(19) United States
(12) Patent Application Publication
(10) Pub. No.: US 2021/0326941 A1
(43) Pub. Date: Oct. 21, 2021

(54) PLATFORM FOR SELF-GOVERNED AND SELF-ORGANIZED GROUPS OF SERVICE PROVIDERS THAT ARE DISCOVERABLE BY GEO-LOCATION

(71) Applicant: Fireflies Platform LLC, Beaverton, OR (US)

(72) Inventors: Dulith HERATH, Beaverton, OR (US); Sivaaji DE ZOYSA, Colombo 05 (LK)

(21) Appl. No.: 16/531,621

(22) Filed: Aug. 5, 2019

Related U.S. Application Data
(60) Provisional application No. 62/806,408, filed on Feb. 15, 2019.

(51) Int. Cl. G06Q 30/02; G06F 16/9537; G06F 16/29; G06F 9/451

(52) U.S. Cl. CPC G06Q 30/0282; G06F 9/451; G06F 16/29; G06F 16/9537

(57) ABSTRACT

Disclosed herein are embodiments of systems, methods, and products comprises a server for selecting a service provider. The server receives a request for a type of service from a user. The server determines a set of service providing entities offering services satisfying the user request and within a certain distance from the user's geolocation. After the user selects a particular service providing entity from the set of service providing entities, the server executes an independently configured algorithm of the particular service providing entity to select a service provider. The server transmits a service request to the service provider's electronic device. As the service provider fulfills the user request, the server periodically monitors the geolocations of the service provider and the user and display their real time geolocations on a map interface until the request has been completed.

### CROSS-REFERENCE TO RELATED APPLICATIONS

This application claims priority to U.S. Provisional Patent Application Ser. No. 62/806,408, entitled “A Platform for Self-Governed and Self-Organized Groups of Service Providers That Are Discoverable by Geo-Location,” filed Feb. 15, 2019, which is hereby incorporated by reference in its entirety.

### TECHNICAL FIELD

This application relates generally to methods and systems for selecting service providers from independently configured service providing entities.

### BACKGROUND

As the processing power of computers allows for greater computer functionality and the Internet technology era allows for interconnectivity between computing systems, there are many applications connecting users to service providers. However, these applications have several technical shortcomings.

First, each existing application is generally associated with one service. Users looking for different services may need to visit different websites, download different applications, or contact different people to get the right services. Second, it is difficult for the existing applications to connect users with small groups of service providers. Small groups of service providers may not have their own applications or websites. It is difficult for these small groups to create their own applications and take them to market. Even if they create such an application, it is not likely to gain traction, due to its locality limitation. Third, existing platforms for connecting users and service providers may require the service providers to comply to or agree with the terms of the platforms. The existing platforms do not allow the service providers meaningful control over their work rules and compensation mechanism and other administrative management. In other words, the existing platforms are overly centralized, not customizable, and do not inherently have the flexibility to be deployed by different types of service providers.

As such, a significant improvement upon platforms hosting service providers to connect them to users is therefore required.

### SUMMARY

For the aforementioned reasons, what is needed is a system and method to connect users with small groups of service providers offering different types of services. What is further needed is a system and method that allows the service providers self-governance and self-organizing over their service management.

Embodiments disclosed herein address the above challenges by providing a system and method for selecting a service provider. Specifically, an analytic server may receive a request for a type of service from a user. The request may include one or more parameters for service requirements and a geolocation of the user. The analytic server may select a subset of service providing entities from a plurality of service providing entities. The subset of service providing entities may satisfy the user's service requirements and provide services within the user's area (e.g., within a certain distance from the user's geolocation). After the user selects a particular service providing entity from the subset of service providing entities, the analytic server may execute an independently configured algorithm of the particular service providing entity to select a service provider. The analytic server may transmit a service request to the service provider's electronic device. As the service provider fulfills the user request, the analytic server may periodically monitor the geolocations of the service provider and the user and display their real time geolocations on a map interface until the analytic server receives an indication that the request has been completed.

In one embodiment, a computer-implemented method of selecting a service provider from a plurality of service providing entities each including a plurality of service providers and each executing a corresponding independently configured algorithm, the method comprises receiving, by a computer, a request for a type of service from a client application on a first electronic device, the request including one or more parameters and a geolocation of the first electronic device; retrieving, by the computer from a database, data records associated with a subset of service providing entities from the plurality of service providing entities based upon a query utilizing the one or more parameters and the type of service at a location identified by the geolocation; receiving, by the computer, a selection of a service providing entity of the subset of the plurality of service providing entities; executing, by the computer, an independently configured algorithm of the service providing entity to select a service provider of the service providing entity; transmitting, by the computer, a service request to a service provider application on a second electronic device of the service provider; and periodically monitoring, by the computer, geolocations of the first and second electronic devices until the computer receives an indication that the requested service has been completed.

In another embodiment, a system comprises a non-transitory storage medium storing a plurality of computer program instructions; and a processor electrically coupled to the non-transitory storage medium and configured to execute the plurality of computer program instructions to: receive a request for a type of service from a client application on a first electronic device, the request including one or more parameters and a geolocation of the first electronic device; retrieve, from a database, data records associated with a subset of service providing entities from a plurality of service providing entities based upon a query utilizing the one or more parameters and the type of service at a location identified by the geolocation, each of plurality of service providing entities including a plurality of service providers and executing a corresponding independently configured algorithm; receive a selection of a service providing entity of the subset of the plurality of service providing entities; execute an independently configured algorithm of the service providing entity to select a service provider of the service providing entity; transmit a service request to a service provider application on a second electronic device of the service provider; and periodically monitor geolocations of the first and second electronic devices until the computer receives an indication that the requested service has been completed.

It is to be understood that both the foregoing general description and the following detailed description are exemplary and explanatory and are intended to provide further explanation of the disclosed embodiment and subject matter as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates components of a system for selecting service providers, according to an embodiment.

FIG. 2 illustrates an example of a service providing entity hierarchy, according to an embodiment.

FIG. 3 illustrates a system diagram of a platform as a service (PaaS), a service provider facing application, and a client facing application, according to an embodiment.

FIG. 4 illustrates a flowchart depicting operational steps for selecting service providers, according to an embodiment.

FIG. 5A illustrates an example of a graphical user interface for users after login, according to an embodiment.

FIG. 5B illustrates an example of a graphical user interface for users to select one or more services, according to an embodiment.

FIG. 5C illustrates an example of a graphical user interface for users to select one of the service providing entities, according to an embodiment.

FIG. 5D illustrates an example of graphical user interface for users to book a service, according to an embodiment.

FIG. 5E illustrates an example of a graphical user interface displaying real time geolocations of a service provider, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Embodiments disclosed herein provide a platform-as-a service (PaaS) that allows the service providers to self-govern and self-organize the operations and managements of their services. For example, the service providers may have control over work hours, fees for services, revenue sharing, dispatching, and other rules. Embodiments disclosed herein provide a system and method to decentralize the control of the platform while still connecting customers with service providers offering different types of services.

Embodiments disclosed herein describe an application platform that allows service providers to create their own self-governed organization, such as service providing entities (also referred to as “colonies”), thus providing decentralized control of the services. Each service providing entity may have their own governance structures. The embodiments disclosed herein may provide a web-based interface to allow the service providers to access to an administrative back-end (e.g., a service provider facing application), which may comprise tools to generate and manage the service providing entities (e.g., colonies). In addition, the interface may allow service providers to customize the features and functionalities of the client facing application. Therefore, each of the service providing entities may self-organize setting its own governance structure and rules of operation.

Embodiments disclosed herein provide systems and methods for selecting a service provider. An analytic server may receive a request for a type of service from a user. The analytic server may determine a set of service providing entities offering services satisfying the user request and within a certain distance from the user's geolocation. After the user selects a particular service providing entity from the set of service providing entities, the analytic server may execute an independently configured algorithm of the particular service providing entity to select a service provider. The analytic server may transmit a service request to the service provider's electronic device. As the service provider fulfills the user request, the analytic server may periodically monitor the geolocations of the service provider and the user and display their real time geolocations on a map interface until the request has been completed.

By executing the independently configured algorithm of the service providing entity, the analytic server may allow each service providing entity to have self-governed and self-organized structure and management. The independently configured algorithm of each service providing entity may not only for selecting a particular service provider, but also for any other administrative management, such as control over work hours, fees for services, revenue sharing, dispatching, and other rules.

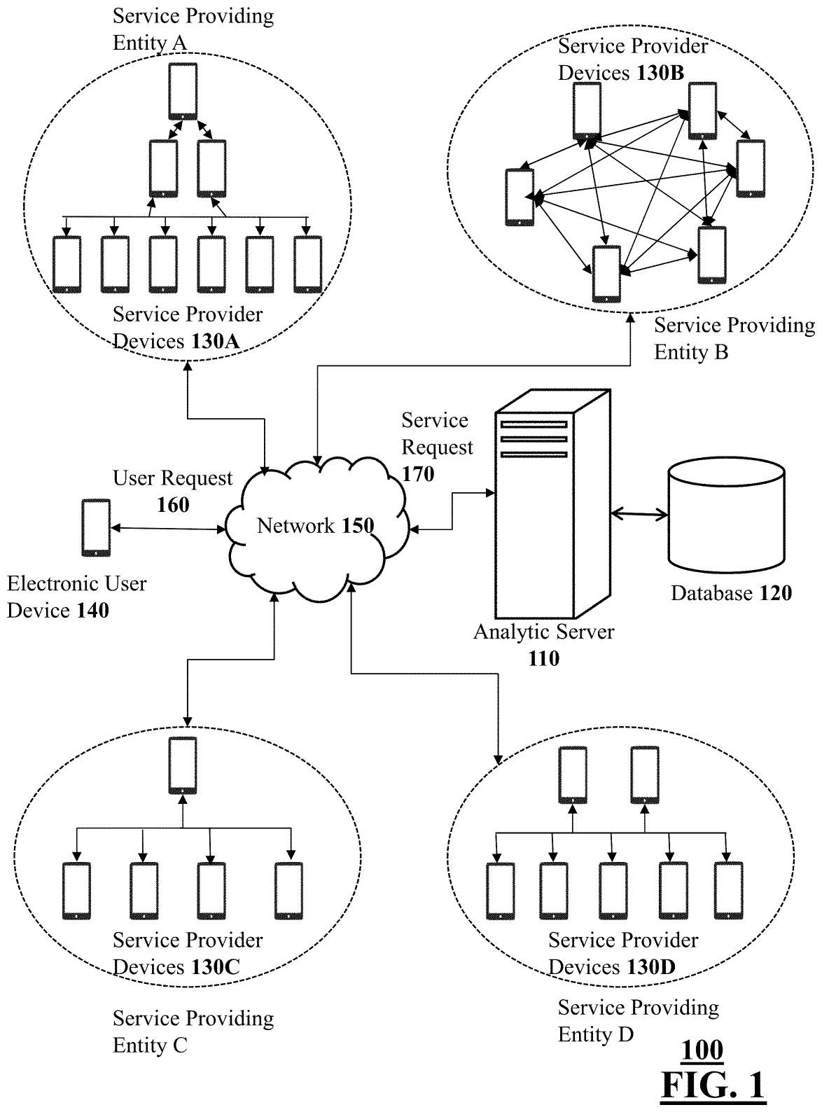

FIG. 1 illustrates components of a system 100 for selecting service providers, according to an embodiment. The system 100 may comprise an analytic server 110, a database 120, a set of service provider devices 130A, 130B, 130C, 130D (collectively and commonly referred to as 130) from a plurality of service providing entities (service providing entities A, B, C, D), and an electronic user device 140 that are connected with each other via hardware and software components of one or more networks 150. Examples of the network 150 include, but are not limited to, Local Area Network (LAN), Wireless Local Area Network (WLAN), Metropolitan Area Network (MAN), Wide Area Network (WAN), and the Internet. The communication over the network 150 may be performed in accordance with various communication protocols, such as Transmission Control Protocol and Internet Protocol (TCP/IP), User Datagram Protocol (UDP), and IEEE communication protocols.

The analytic server 110 may be any computing device comprising a processor and other computing hardware and software components, configured to receive and process electronic requests. The analytic server 110 may be logically and physically organized within the same or different devices or structures, and may be distributed across any number of physical structures and locations (e.g., cabinets, rooms, buildings, cities).

The analytic server 110 may be a computing device comprising a processing unit. The processing unit may include a processor with computer-readable medium, such as a random access memory coupled to the processor. The analytic server 110 may be running algorithms or computer executable program instructions, which may be executed by a single processor or multiple processors in a distributed configuration. The analytic server 110 may be configured to interact with one or more software modules of a same or a different type operating within the system 100.

Non-limiting examples of the processor may include a microprocessor, an application specific integrated circuit, and a field programmable object array, among others. Non-limiting examples of the analytic server 110 may include a server computer, a workstation computer, a tablet device, and a mobile device (e.g., smartphone). Some embodiments may include multiple computing devices functioning as the analytic server 110. Some other embodiments may include a single computing device capable of performing the various tasks described herein.

The electronic user device 140 may be any computing device allowing a user to interact with the analytic server 110. The electronic user device 140 may be any computing device comprising a processor and non-transitory machine-readable storage medium. The examples of the computing device may include, but are not limited to, a desktop computer, a laptop, a personal digital assistant (PDA), a smartphone, a tablet computer, and the like. The electronic user device 140 may comprise any number of input and output devices supporting various types of data, such as text, image, audio, video, and the like.

Furthermore, the electronic user device 140 may have positioning capabilities to track geolocations of the device. The electronic user device 140 may use a number of technologies to enable geolocation tracking, such as using multilateration of radio signals between (several) cell towers of the network and the electronic user device 140, or simply using GPS (global positioning system). The electronic user device 140 may have one or more GPS sensors embedded. GPS sensors are receivers with antennas that use a satellite-based navigation system with a network of 24 satellites in orbit around the earth to provide position, velocity, and timing information.

A user operating the electronic user device 140 may issue an electronic request for a certain service. For example, a customer may request one or more services by issuing an electronic request via an application (e.g., client facing application) running on the electronic user device 140. The user may initiate electronic request by interacting with a graphical user interface (GUI) provided by the analytic server 110. For example, the user may enter one or more parameters in the GUI and request a moving service. Users may initiate electronic requests through web applications (e.g., comprising a hyperlink of a website) and/or mobile applications installed in the electronic user devices 140. A user may request multiple different services via the application. Each of the plurality of service providing entities may provide a particular kind of service. The analytic server 110 may select a subset of service providing entities to satisfy the user request.

The service provider devices 130 may be any computing device allowing a service provider to interact with the analytic server 110. The service provider devices 130 may be any computing device comprising a processor and non-transitory machine-readable storage medium. The examples of the computing device may include, but are not limited to, a desktop computer, a laptop, a personal digital assistant (PDA), a smartphone, a tablet computer, and the like. The service provider devices 130 may comprise any number of input and output devices supporting various types of data, such as text, image, audio, video, and the like. Furthermore, the service provider devices 130 may have positioning capabilities to track geolocations of the device. The service provider devices 130 may use a number of technologies to enable geolocation tracking, such as using multilateration of radio signals between (several) cell towers of the network and the service provider devices 130, or simply using GPS. The service provider devices 130 may have one or more GPS sensors embedded.

Each service provider operating the service provider devices 130 may belong to one or more service providing entities. The service providing entities may be a community, a company, or an organization of a small group of people that provide a certain service. For example, one service providing entity may be a community comprising a group of drivers; another service providing entity may be a community comprising a group of movers. Furthermore, there may be multiple service providing entities for the same services. Each service providing entity may have its own databases and software and hardware resources.

The service providing entity may be self-governed and self-organized community. Each of the service providing entities is independently configured. Each service providing entity may have their own independently configured algorithm for the entity's operation and management. The analytic server 110 may receive the user request comprising one or more parameters and the geolocation of the user. The analytic server 110 may select a subset of entities that provide services satisfying the user request. The analytic server 110 may select service providing entities not only providing the required service but also having service providers located within a predetermined distance from the geolocation of the user. The analytic server 110 may activate the GPS sensors in the user device 140 and the service provider device 130 to track their geolocations.

The analytic server 110 may render and display a GUI comprising the subset of service providing entities on the user device 140. Based on the user's selection, the analytic server may identify a service provider from the selected service providing entity. The analytic server 110 may execute the algorithm of the selected service providing entity to identify a particular service provider. The analytic server 110 may periodically collect the geolocations of the electronic user device 140 and the service provider device 130. The analytic server 110 may also render a GUI, such as a map interface, to display the real time geolocations of the user and the service provider.

The database 120 may be any non-transitory machine-readable media configured to store the user data, the service providing entity data and the service provider data. For example, user data in the database 120 may comprise the user ID, user credential, user's historical requests, user attributes (e.g., address, age, gender, contact information, and the like), payment methods, and any other related information about the user. The service providing entity data in the database 120 may comprise the service provided by each service providing entity, the entity rating, the location of the entity, the number of service providers in the entity, the rules/policies of each entity, and the like. The service provider data in the database 120 may comprise the service provider ID, credentials, historical services satisfying user requests, service provider attributes (e.g., address, age, gender, contact information, and the like). The service provider data may also comprise the skill set, the spoken languages, the work hours, the service features (e.g., the vehicle type, the vehicle capacity of a driver), and the like. Each service providing entity may have their own databases (not shown) to manage the service and the service provider members. The analytic server 110 may have the authorization to access the databases of each service providing entity.

The database 120 may be part of the analytic server 110. The database 120 may be a separate component in communication with the analytic server 110. The database 120 may have a logical construct of data files, which may be stored in non-transitory machine-readable storage media, such as a hard disk or memory, controlled by software modules of a database program (e.g., SQL), and a database management system that executes the code modules (e.g., SQL scripts) for various data queries and management functions.

The analytic server 110 may be connected to the electronic user device 140 and the service provider devices 130 via the network 150. The analytic server 110 may receive an electronic user request 160 from the user device 140 requesting one or more services. The analytic server 110 may retrieve data records of the plurality of service providing entities and the data records of service providers in each entity from the database 120. The analytic server 110 may identify a service provider satisfying the user request. The analytic server 110 may transmit an electronic message comprising a service request 170 to the service provider device 130 associated with the identified service provider. The service request may notify the service provider with the user requirements and any other additional information about the user and the request. As the service provider fulfills the user request 160, the analytic server 110 may render a map interface on the electronic user device 140 and the service provider device 130 displaying their real time geolocations.

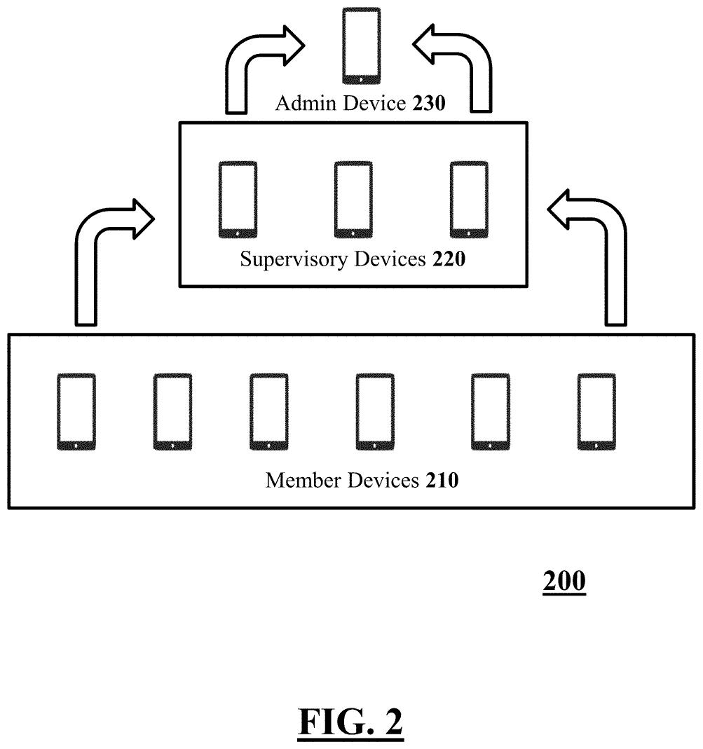

FIG. 2 illustrates an example of a service providing entity hierarchy 200, according to an embodiment. Each service providing entity (also referred to as “colony”) is self-governed and determines its own rules for membership, leadership, profit sharing, work-assignment, quality of service, and the like. The analytic server may provide a service provider facing application that comprises modules and tools for setting up the hierarchy of the service providing entity. For example, the service providers of an entity may select a group leader or other entity through periodic voting or other mutually determined procedure. In one or more embodiments, a default selection process may be suggested by the application, such as a quarterly secret voting system managed by the application platform.

The hierarchy 200 may include a set of members of the entity/colony operating the member devices 210. The set of members may select a management committee (operating the supervisory devices 220) and a group leader (operating the admin device 230). In some embodiments, the group leader (operating the admin device 230) may be the founder of the colony. The group leader (operating the admin device 230), or other entity selected by the regional colony such as the management committee (operating the supervisory devices 220), may be responsible for checking the skill level, personality, temperament, and other attributes of each service provider in the colony and be responsible for regular upskilling programs for the group. Finance, insurance, education, health and medical services providers, etc. may work with the leader to design packages to suit the colony and once designed and curated, these services may be available and accessible to the colony through the service provider facing application.

The leadership of a colony may also be responsible for implementing polices agreed upon by service provider members of the colony, such as structuring a fee schedule for services provided by the members of the colony. Because each colony operates independently of each other, each colony may enact different policies and remain autonomous from each other and the centralized platform. For example, one colony may form around truck drivers offering their skills and large vehicles for moving purposes or for the delivery of large goods such as home renovation supplies. Another colony may form around drivers offering their skills and vehicles exclusively for airport pick-up and drop-off services. The different services provided by each colony may have different organizational and governance needs. For example, the truck driver colony may organize its service providers into groups based on the carrying capacity of their vehicles and develop work assignment rules appropriate for the carrying capacity associated with each group. This kind of self-organization and work assignment structure may be useless to the airport pick-up and drop-off service colony. The pick-up and drop-off service colony may develop its own structure that is different from the truck driver colony. The autonomy provided to each colony may allow the colony to self-govern its service management according to its unique needs and service provider members.

Therefore, systems and methods described herein therefore provide a platform for colonies to independently self-organize. The platform may provide an interface and tools to create colonies. For instance, the platform may provide a downloadable application (e.g., a smartphone application) that a user can download to start a colony. The application may have configuration settings for the creator of the colony to set the management structure, distribution of revenue, and the sequence of dispatch of individual service providers in the colony. The colony creator may also allow the individual service providers to require a vote on the matters affecting the colony. Individual service providers may be free to leave and join any colony. For instance, a service provider of a first colony may not be satisfied with the first colony and start a second colony. The colony may also choose its own management and hierarchy of service providers.

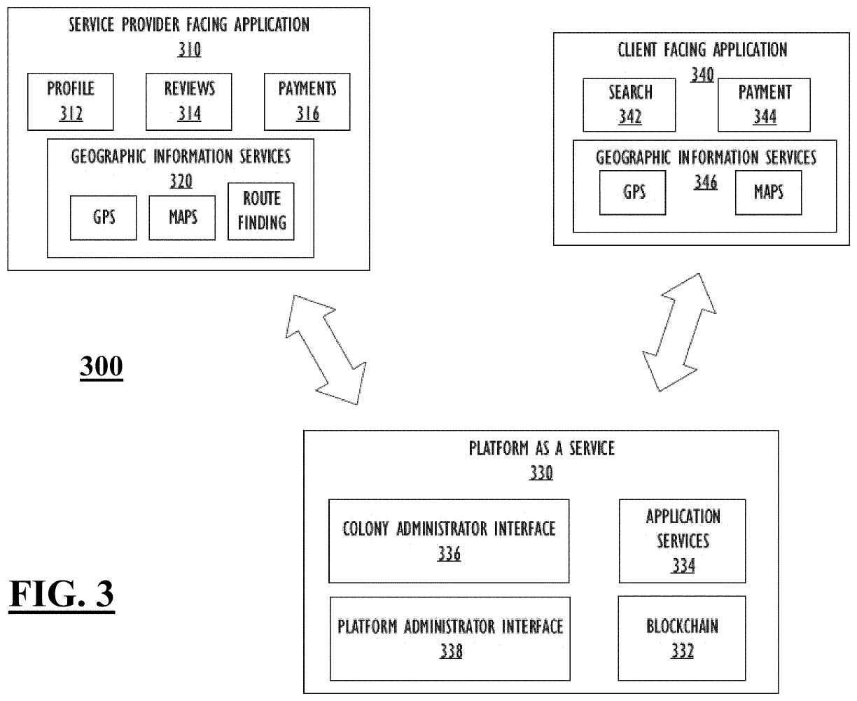

FIG. 3 illustrates a system diagram 300 of a platform as a service (PaaS) 330, a service provider facing application 310, and a client facing application 340, according to an embodiment. The PaaS 330 may include application services 334, blockchain 332, colony administrator interface 336, and platform administrator interface 338. The service provider facing application 310 may include a profile 312, reviews 314, payments 316, and geographic information services 320, such as GPS tracking, map services, and route finding services. The client facing application 340 may include a search function 342, payment 344, and geographic information services 346, such as GPS tracking and map services.

The application services 334 in the PaaS 330 may enable various interactions, such as the search function 342. A customer may use the search function 342 in the client facing application 340 to search for service providers meeting certain criteria, such as qualifications and a threshold review level (rating level). The profile 312 in the service provider facing application 310 may include a service provider's qualifications and reviews 314 associated with the service provider. The application services 334 may enable a search of profile 312 and reviews 314 to determine if the service provider matches the criteria from search function 342. The application services 334 may further include payment gateways, geographic information services, dynamic and global cloud storage of service provider and customer data, and other features. The analytic server may utilize payment gateways to integrate payments from the payment module 344 in the client facing application 340 or the payment module 316 in the service provider facing application 310 to a third-party payment service. In other embodiments, payment gateways may enable payment through cryptocurrency or other digital commodities such as server time and the like. The analytic server may use geographic information services to implement dynamic maps and geolocation, in both the geographic information services 320, 346 in the service provider facing application 310 and the client facing application 340. After dispatching, the analytic server may show a dynamic map as well as directions to the customer in the service provider facing application 310.

The blockchain 332 in the PaaS 330 may enable blockchain for secure and trusted transactions, identity and ledger publication. The analytic server may utilize the blockchain 332 to store records required for regulatory or auditing purposes. For example, the analytic server may use the blockchain 332 to store transaction records required to audit a colony. In another example, the analytic server may use the blockchain 332 to store credentials, such as commercial truck driving licenses for service providers, such that clients (also referred to as users) looking for commercial truck driving services may be assured of the service provider's compliance with all regulatory standards. The commercial truck driving licenses may also be associated with their renewal or expiration dates, such that a service provider whose license expires cannot forge a later date on the licensing information available to customers. The analytic server may also use the blockchain 332 to store ratings of service providers and clients and other data for human participants, such as addresses, payment information, and the like. The analytic server may also use the blockchain 332 to implement multiple blockchains concurrently, and the description of the blockchain 332 as a single blockchain is merely illustrative. For example, the analytic server may use a first blockchain for full record keeping of corporate transactions and may be available only to auditors or group leaders. The analytic server may use a second blockchain for publicly visible information such as service provider or customer ratings, pricing models, and the like. The analytic server may use a third blockchain to store secure identity information and other metadata for human participants. For example, the third blockchain may store individual user data and individual service provider data. This individual data may be used by PaaS 330 only if a corresponding individual (e.g., user or service provider) has provided an express permission. For one or more of the blockchains described above, the PaaS 330 may deposit records using blockchain 332 intermittently. In some embodiments, lightning network (a payment protocol that operates on top of a blockchain-based cryptocurrency) and summaries may be added through the blockchain 332 when available.

The colony administrator interface 336 may enable colony leadership to structure the colony by setting and modifying work or profit-sharing rules, assigning service requests to particular service providers, adding or removing members, and the like. The colony administrator interface 336 may allow a colony to customize the features of the colony's interface on both the service provider facing application 310 and the client facing application 340. The customization may generate a distinct application for each colony while avoiding the overhead of maintaining the large number of applications for the plurality of colonies. The colony administrator interface 336 may also enable colony leadership to offer upskill materials and finance, insurance, education, and health and medical services packages to colony members.

The platform administrator interface 338 may enable staff of the PaaS 330 to manage site parameters, control payment accounts, function as customer service, generate corporate reports, and the like. The platform administrator interface 338 may also enable platform administrators to check on colonies that operate outside of predetermined guidelines and/or regulations. In some embodiments, the platform administrator interface 338 may enable staff of PaaS 330 to distribute lump sum of the revenues collected for work done by a colony's service providers to that colony, withhold or delay payments to colonies, or create a reward process withholding a sum of money from all colonies associated with the PaaS 330 and distributing the sum as a reward to a subset of colonies who meet certain criteria. For example, the PaaS 330 may distribute the sum as a reward to the colonies who bring in revenue above a threshold amount or gain a certain number of new customers over a period of time. The platform administrators may set and change the criteria dynamically. The PaaS may transmit both the criteria and the reward distributions to colonies associated with the PaaS 330 through a report. The PaaS 330 may further transmit rewards to service providers based upon their user ratings. For example, a service provider may receive a reward from the PaaS 330 if the service providers receives high user ratings over a predetermined time window (e.g., a month). The PaaS 330 may also transmit rewards to users who have received high service provider ratings over a predetermined time window. For example, if a user uses a service provider's facilities and leaves the facilities in the same or better condition, the service provider may provide a high rating to the user. For a highly rated user, the PaaS 330 may transmit one or more rewards to the corresponding client facing application (e.g., client facing application 340).

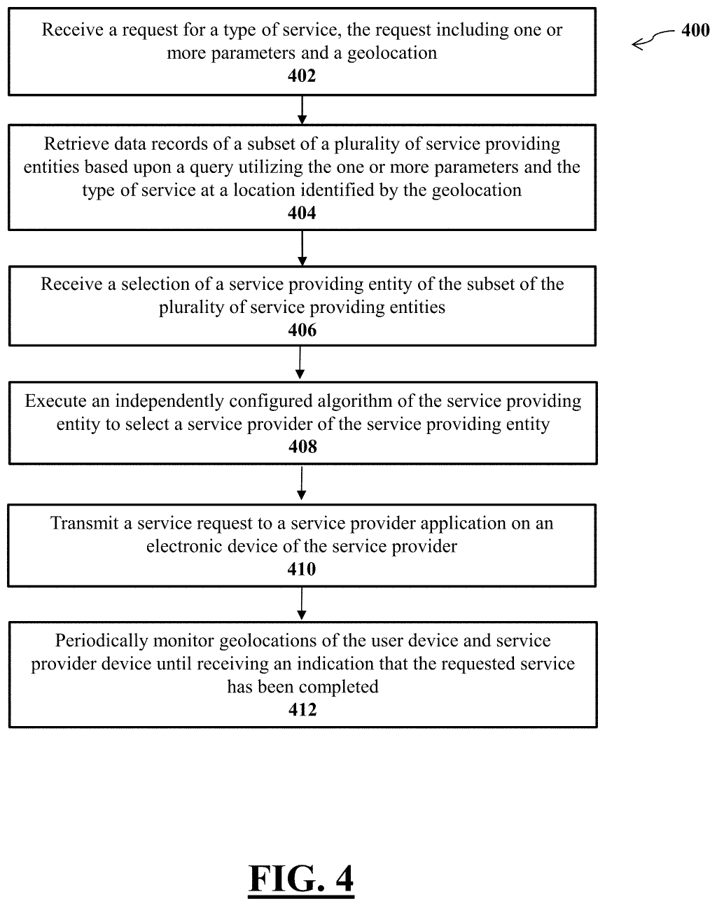

FIG. 4 illustrates a flowchart depicting operational steps 400 for selecting service providers, according to an embodiment. Other embodiments may comprise additional or alternative steps, or may omit some steps altogether.

At step 402, an analytic server may receive a request for a type of service, the request including one or more parameters and a geolocation. The analytic server may receive an electronic request from a client application (e.g., client facing application) running on a user device. In operation, the user may initiate the electronic request through web applications (e.g., comprising a hyperlink of a website) and/or mobile applications installed in the electronic user device. The user may log into the application using user credentials (e.g., user name and password).

The analytic server may display a plurality of service types on a GUI of the client application. The user may request one or more services via the application. For example, the user may request a mover service or any other services via the application. The user may input one or more parameters for the required service. For example, the user may request that the driver of the truck can speak Spanish, and the truck is a large enough vehicle that can hold the entire items to be moved.

The analytic server may receive the user's request through the application. Furthermore, the analytic server may activate one or more sensors in the user device to obtain additional information. For example, the analytic server may activate the GPS sensor and obtain the user's geolocation. The received electronic request may comprise the type of service, the one or more parameters of the required service, and the geolocation.

At step 404, the analytic server may retrieve data records of a subset of a plurality of service providing entities based upon a query utilizing the one or more parameters and the type of service at a location identified by the geolocation. Each of the plurality of service providing entities is a self-governed, self-organized group with different structures or hierarchies. The service providing entity may be a community, a company, or an organization of a small group of people that provide a particular type of service. For example, one service providing entity may be a community comprising a group of drivers; another service providing entity may be a community comprising a group of movers. Furthermore, there may be multiple service providing entities for the same services. Each service providing entity may have its own databases and software and hardware resources.

The analytic server may select a subset of service providing entities from the plurality of service providing entities. The selected subset of service providing entities may satisfy the user's request. In operation, the analytic server may access the databases of the service providing entities, retrieve and query the data records of the databases based on the one or more parameters, the type of service and the geolocation. The analytic server may select service providing entities not only providing the required service but also having service providers located within a predetermined distance from the geolocation of the user.

For example, the analytic server may receive the user request for a mover service. The user may request that the driver of the truck can speak Spanish, and the truck is a large enough vehicle that can hold all the items to be moved. The analytic server may determine a set of entities providing moving services that satisfy the language and vehicle requirements. Furthermore, the analytic server may determine the locations of the truck drivers from the service providing entities. The analytic server may determine if the drivers are within a certain distance (e.g., a threshold) from the user's geolocation. The analytic server may select the service providing entities whose drivers are close to the user (e.g., distance within a threshold) and satisfy the language and vehicle requirements.

The analytic server may generate a graphical user interface comprising interactive components of the subset of service providing entities satisfying the user request. The GUI may also include a rating for each of the service providing entity. The rating for each entity maybe based on the ratings of the service providers in that entity. For example, the entity rating may be the average value of all the service provider members' ratings within that entity. The GUI may include additional information on each entity, such as the number of service providers in each entity, the minimum price, and the like. The GUI may display the interactive components of the subset of service providing entities based on a ranking of their ratings and/or geo-proximity to the user geolocation (e.g., user's device geolocation), and any other limitations set by the user.

At step 406, the analytic server may receive a selection of a service providing entity of the subset of the plurality of service providing entities. The analytic server may render the GUI comprising the subset of service providing entities on the user device via the application. The user may be able to select one of the service providing entities by interacting with the GUI. The analytic server may receive the user's selection via the application, which comprises the identifier (ID) of the selected service providing entity.

At step 408, the analytic server may execute an independently configured algorithm of the service providing entity to select a service provider of the service providing entity. After the selection of the service providing entity, the analytic server may select a particular service provider from that service providing entity to serve the user. To enable the self-governance and self-organizing of each entity, the analytic server may execute the algorithm of the selected service providing entity to select the service provider. The independently configured algorithm of the service providing entity may also be configured for management of rules including work hours, fees for services, revenue sharing, dispatching of service providers within the service providing entity.

The independently configured algorithm of each service providing entity may allow the entity to design and configure their own methodology based on their own requirements and preferences. The algorithm may be configured for the whole process of the entity's operation, including selecting a particular service provider, determining the price for the service, determining the compensation mechanism for service provider members, determining the distribution of the profit within the entity, and the like.

In some embodiments, the selection algorithm may identify the service provider based on the real time geolocation of the service provider. For example, the selection algorithm may have a certain parameter defining the distance threshold from the service provider's geolocation to the user's geolocation. The threshold value may be configured by the service providing entity or the analytic server. The selected service provider may be close to the user, such as within the distance threshold from the user's geolocation. Furthermore, the identifying of the service provider may be based on the service provider's availability status. The selected service provider may be available at the moment the user issues the request.

In some embodiments, the selection algorithm of the service providing entity may identify a plurality of service providers satisfying the requirements of the user request. The selection algorithm may rank the plurality of service providers based on one or more attributes. For example, the ranking of the plurality of service providers may be based on their ratings and/or geo-proximity to the user, and any other limitations set by the user. The highest ranked service provider may be the selected service provider.

At step 410, the analytic server may transmit a service request to a service provider application on an electronic device of the service provider. The service providers of each service providing entity may have a service provider application (e.g., service provider facing application) downloaded and installed in their electronic devices. The analytic server may provide applications with different functions for different services. For example, the taxi drivers' application may have different functions from the movers' application.

The analytic server may notify the selected specific service provider by transmitting a service request to the service provider's electronic device via the service provider application. The service request may comprise the requirement of the user, such as time, location, requested service, and any other additional information about the user and/or the request. For example, the selected truck driver may receive the service request comprising the user ID, service time, user location and the user's special requirements. In some embodiments, the service request may also include methods to fulfill the user request determined by the service providing entity and rules/policies of the service providing entity. For example, the selected truck driver may also receive the route/path from the driver's geolocation to the user's geolocation, and any other relevant information (e.g., traffic, weather). The analytic server may generate and display a map interface on the driver's device and show the user's geolocation and the path to reach the user's geolocation on the map.

The analytic server may transmit an electronic message to the selected service provider's electronic device via the service provider application. The electronic message may comprise the service request and any other related information. Furthermore, the electronic message may comprise interactive components (e.g., buttons) for the service provider to confirm or decline the service request. If the selected service provider declines the service request, the analytic server may select a second service provider satisfying the requirements of the user request. The analytic server may transmit the service request to the second service provider. The analytic server may repeat this process until a service provider confirms the service request. If the selected service provider confirms the service request, the analytic server may set the availability status of the service provider as “busy.”

At step 412, the analytic server may periodically monitor geolocations of the user device and the service provider device until the analytic server receives an indication that the requested service has been completed. The analytic server may keep tracking the geolocations of the user and the service provider via the application in their devices. The analytic server may activate the GPS sensors and periodically collect the geolocation data from the user device and the service provider device. The analytic server may render a map interface on both the user device and the service provider device to show the real time geolocations of the user and the service provider.

Furthermore, the analytic server may provide a GUI for updating the service status. When the requested service has been completed, the service provider may interact with the GUI to indicate that the service has been completed. The analytic server may then set the availability status of the service provider as “available.”

For example, in the moving service, the analytic server may keep tracking the geolocations of the user device and the truck driver's device. The analytic server may render a map interface displaying the real time geolocations of the user and the driver on both the user device and the driver device. As the driver reaches the user's destination (e.g., driver's geolocation is within a distance threshold from the user's destination), the analytic server may render the GUI to allow the driver to indicate the service is completed. After the analytic server receives the completed status, the analytic server may generate a GUI on client application of the user device to request the user to review/rate the service provider's service. The analytic server may also generate a GUI on the service provider device to request the service provider to review/rate the user.

The analytic server may transmit the ratings of the service providers to their service providing entity system. The service providing entities may use the ratings of each service provider member for any administrative management based on their own independently configured algorithm. The management within each entity is self-governed.

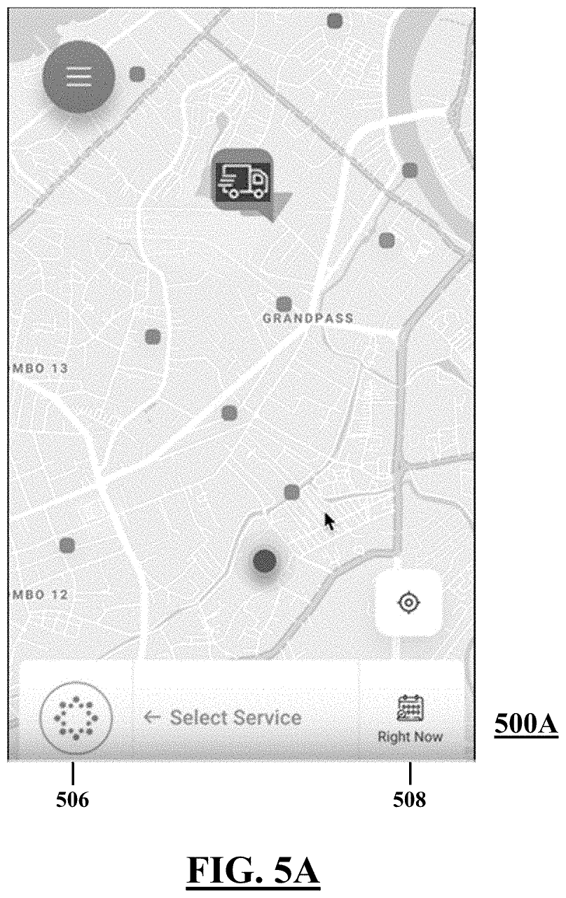

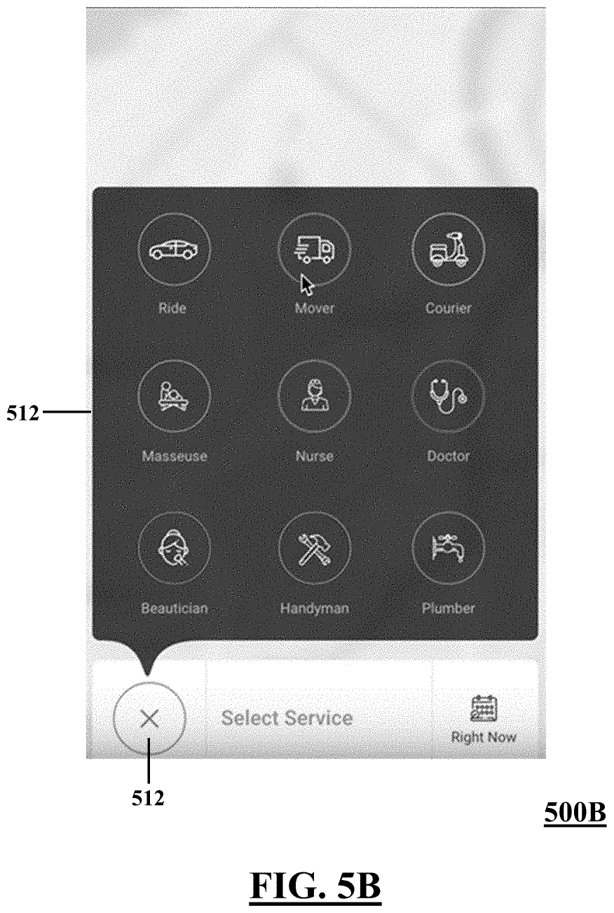

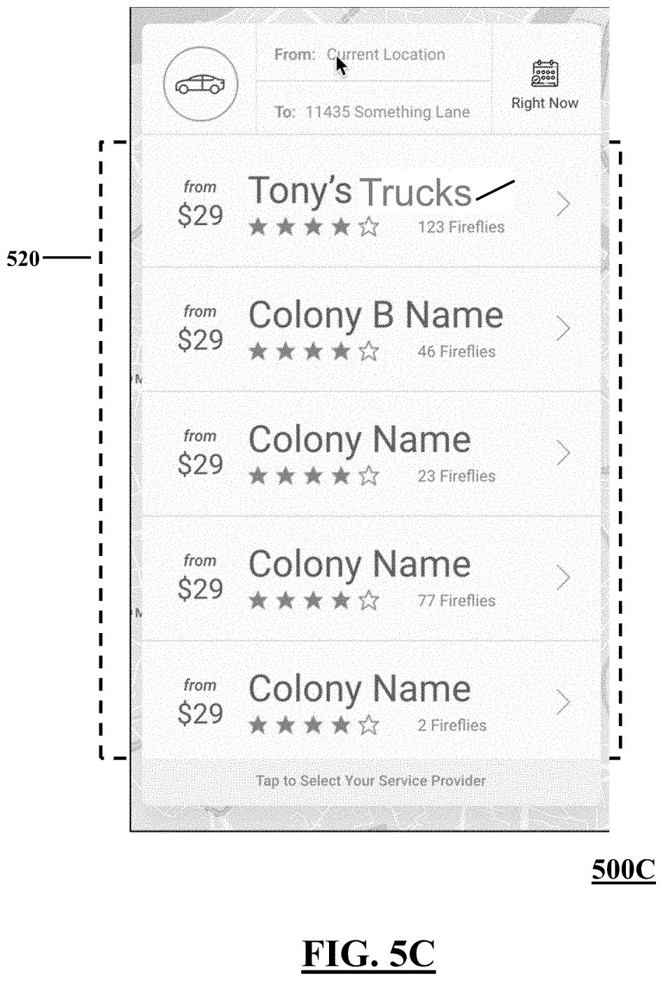

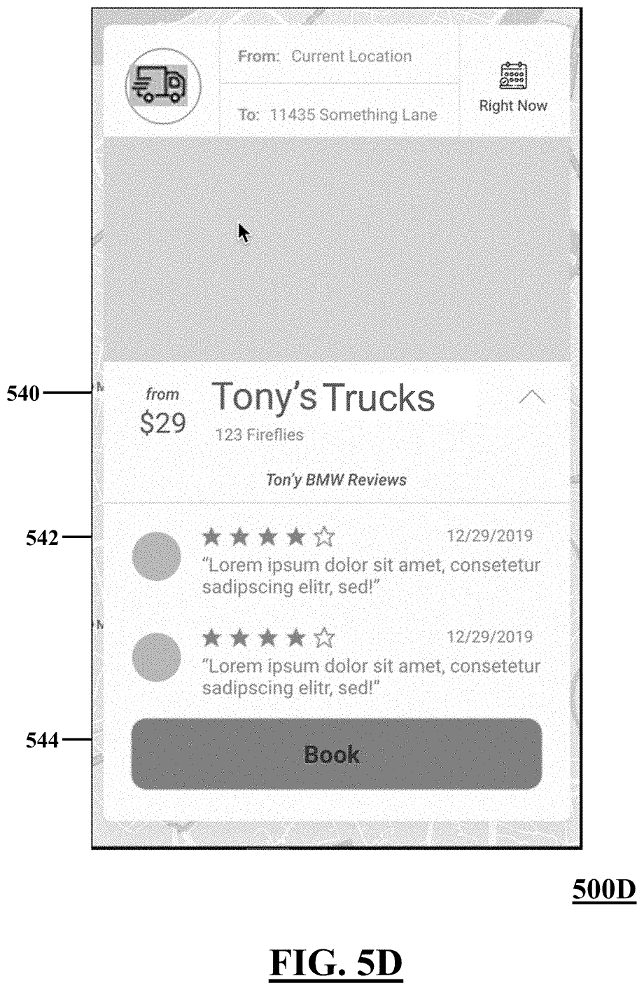

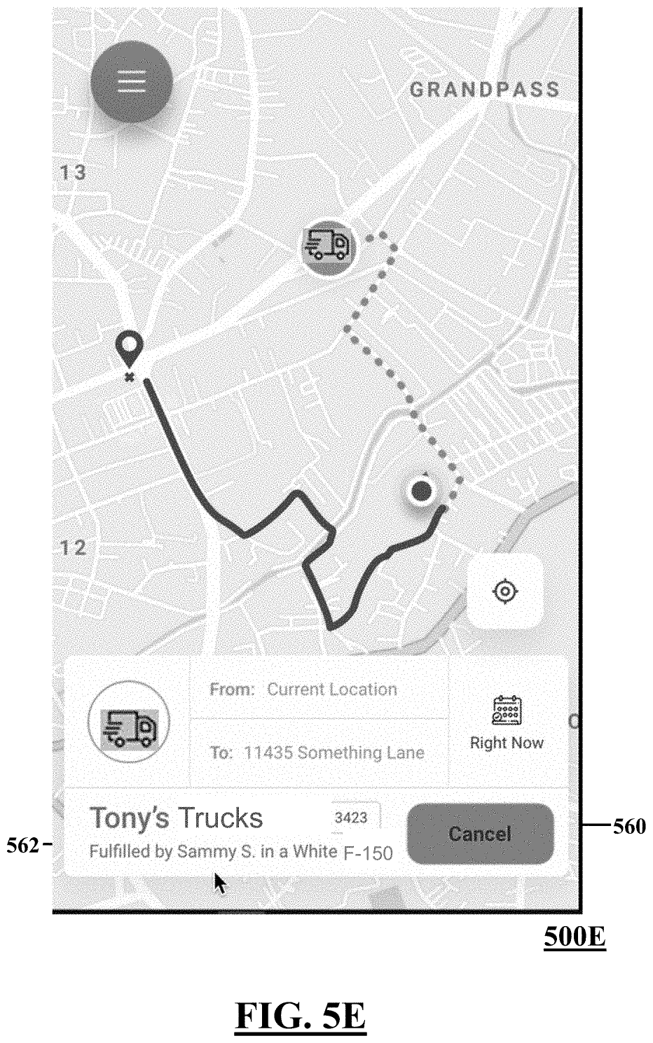

FIG. 5A illustrates an example of a graphical user interface (GUI) 500A for users after login, according to an embodiment. The GUI 500A may show the user's geolocation in a map interface and the geolocations of multiple service providers within the area of the user's current geolocation (e.g., the distance from service provider geolocation to the user geolocation satisfying a threshold). The GUI 500A may display the user's geolocation 502 and the service providers' geolocations 504 as representations in different shapes. For example, the user's geolocation 502 may be a circle, and the service providers' geolocation 504 may be squares. The multiple service providers may be from different colonies and offer different types of services. The representations for the service providers may be in different colors for different services. For example, the taxi drivers may be in red, the movers may be in green. The GUI 500A may include an interactive component 506 that allows the user to select one or more services. The GUI 500A may also include a calendar interface 508 that allows the user to schedule the time for the requested services.

FIG. 5B illustrates an example of a graphical user interface 500B for users to select one or more services, according to an embodiment. The GUI 500B may show a menu 510 including many different types of services, such as ride service, mover, courier, masseuse, nurse, doctor, beautician, handyman, plumber, and the like. The menu 510 may include an interactive graphical element (e.g., icon) to represent each of the services. The user may be able to select one or more services by interact with (e.g., clicking on) the corresponding interactive graphical elements. Furthermore, the GUI 500B may include an interactive element (e.g., a button) 512 to exit the menu 510.

FIG. 5C illustrates an example of a graphical user interface 500C for users to select one of the service providing entities, according to an embodiment. The GUI 500C may show a plurality of service providing entities (e.g., colonies) for a certain service based on the user's selection. For example, assuming the user selects the “moving” service in the GUI 500B of FIG. 5B, the GUI 500C may show a list of the plurality of service providing entities 520 offering “mover” service. For each service providing entity, the GUI 500C may show the service providing entity's ID 522, the minimum price 524, the number of service providers (also referred to as “fireflies”) 526 within the entity, the rating of the entity 528. The GUI 500C may display the plurality of service providing entities 520 according to a ranking of their ratings. Each of the plurality of service providing entities may correspond to an interactive graphical element in the GUI 500C, the user may be able to select an entity by interact with (e.g., clicking on) the corresponding interactive graphical element.

Furthermore, the GUI 500C may include two text-based interfaces 530, 532 for the user to set the departure location and the destination. The default departure location may be the user's current location. The user may be able to edit the departure location and the destination by interacting with the two interfaces 530, 532.

FIG. 5D illustrates an example of graphical user interface 500D for users to book a service, according to an embodiment. After a user selects a service providing entity in GUI 500C of FIG. 5C, the analytic server may render GUI 500D to display information of the selected service providing entity and allow the user to book services from the selected entity. For example, the GUI 500D may include the basic information 540 of the selected entity, such as the entity ID, minimum price, the number of service providers. Furthermore, the GUI 500D may include reviews 542 of the selected entity from other customers. The GUI 500D may also include an interactive element (e.g., button) 544 for the user to book the service. After the user books the service, the analytic server may receive the user's order and further fulfill the order by delivering the booked service.

FIG. 5E illustrates an example of a graphical user interface 500E displaying real time geolocations of a service provider, according to an embodiment. After the user books a certain service from a service providing entity, the analytic server may execute the independently configured algorithm of the service providing entity to select a service provider. In this example, the user may have booked ride service from “Tony's Trucks.” The analytic server may identify a particular service provider “Sammy S.” by executing the algorithm configured by “Tony's Trucks.” The GUI 500E may display the information of the service provider (e.g., “Sammy S.”) 562. The GUI 500E may also include a map interface that shows the user's geolocation 550, the service provider's geolocation 552, and the path 554 from the service provider's geolocation 552 to the user's geolocation 550. The GUI 500E may be dynamically updated to display the real time geolocations of the user and the service provider. The GUI 500E may also include a path 558 from the user's geolocation 550 to the destination 556. The GUI 500E may further include an interactive element (e.g., button) 560 for cancelling the service.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product. The sets of codes and/or instructions may also be stored in the cloud.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A computer-implemented method of selecting a service provider from a plurality of service providing entities each including a plurality of service providers and each executing a corresponding independently configured algorithm, the method comprising:
receiving, by a computer, a request for a type of service from a client application on a first electronic device, the request including one or more parameters and a geolocation of the first electronic device;
retrieving, by the computer from a database, data records associated with a subset of service providing entities from the plurality of service providing entities based upon a query utilizing the one or more parameters and the type of service at a location identified by the geolocation;
receiving, by the computer, a selection of a service providing entity of the subset of the plurality of service providing entities;
executing, by the computer, an independently configured algorithm of the service providing entity to select a service provider of the service providing entity;
transmitting, by the computer, a service request to a service provider application on a second electronic device of the service provider; and
periodically monitoring, by the computer, geolocations of the first and second electronic devices until the computer receives an indication that the requested service has been completed.

2. The computer-implemented method of claim 1, further comprising:
transmitting, by the computer, a plurality of service types for display on a graphical user interface of the client application.

3. The computer-implemented method of claim 1, further comprising:
generating, by the computer, a graphical user interface for rating the service provider on the client application.

4. The computer-implemented method of claim 1, further comprising:
transmitting, by the computer, the subset of service providing entities for display in a graphical user interface based on a ranking of a rating of each service providing entity.

5. The computer-implemented method of claim 1, further comprising:
transmitting, by the computer, the subset of service providing entities for display in a graphical user interface based on a ranking of a geo-proximity of each service providing entity to the geolocation of the first electronic device.

6. The computer-implemented method of claim 1, further comprising:
selecting, by the computer, the service provider based on an availability status of the service provider.

7. The computer-implemented method of claim 1, further comprising:
selecting, by the computer, the service provider based on a real time geolocation of the service provider.

8. The computer-implemented method of claim 1, wherein each of the plurality of service providing entities is independently configured.

9. The computer-implemented method of claim 1, wherein the independently configured algorithm of the service providing entity is configured for at least one of management of rules including work hours, fees for services, revenue sharing, and dispatching of the plurality of service providers within the service providing entity.

10. The computer-implemented method of claim 1, further comprising:
causing to render, by the computer, a map interface on the client application displaying real time geolocations of the service provider.

11. A system comprising:
a non-transitory storage medium storing a plurality of computer program instructions; and
a processor electrically coupled to the non-transitory storage medium and configured to execute the plurality of computer program instructions to:
receive a request for a type of service from a client application on a first electronic device, the request including one or more parameters and a geolocation of the first electronic device;
retrieve, from a database, data records associated with a subset of service providing entities from a plurality of service providing entities based upon a query utilizing the one or more parameters and the type of service at a location identified by the geolocation, each of plurality of service providing entities including a plurality of service providers and executing a corresponding independently configured algorithm;
receive a selection of a service providing entity of the subset of the plurality of service providing entities;
execute an independently configured algorithm of the service providing entity to select a service provider of the service providing entity;
transmit a service request to a service provider application on a second electronic device of the service provider; and
periodically monitor geolocations of the first and second electronic devices until the computer receives an indication that the requested service has been completed.

12. The system of claim 11, wherein the processor is configured to further execute the plurality of computer program instruction to:
transmit a plurality of service types for display on a graphical user interface of the client application.

13. The system of claim 11, wherein the processor is configured to further execute the plurality of computer program instruction to:
generate a graphical user interface for rating the service provider on the client application.

14. The system of claim 11, wherein the processor is configured to further execute the plurality of computer program instruction to:
transmit the subset of service providing entities for display in a graphical user interface based on a ranking of a rating of each service providing entity.

15. The system of claim 11, wherein the processor is configured to further execute the plurality of computer program instruction to:
transmit the subset of service providing entities for display in a graphical user interface based on a ranking of a geo-proximity of each service providing entity to the geolocation of the first electronic device.

16. The system of claim 11, wherein the processor is configured to further execute the plurality of computer program instruction to:
select the service provider based on an availability status of the service provider.

17. The system of claim 11, wherein the processor is configured to further execute the plurality of computer program instruction to:
select the service provider based on a real time geolocation of the service provider.

18. The system of claim 11, wherein each of the plurality of service providing entities is independently configured.

19. The system of claim 11, wherein the independently configured algorithm of the service providing entity is configured for at least one of management of rules including work hours, fees for services, revenue sharing, and dispatching of the plurality of service providers within the service providing entity.

20. The system of claim 11, wherein the processor is configured to further execute the plurality of computer program instruction to:
cause to render a map interface on the client application displaying real time geolocations of the service provider.
